(19) United States
(12) Patent Application Publication
(10) Pub. No.: US 2009/0008219 A1
(43) Pub. Date: Jan. 8, 2009

(54) Linear vibratory conveyor

(76) Inventors: Christian Boeger, Regensburg (DE); Franz Edbauer, Teublitz (DE)

Correspondence Address: JORDAN AND HAMBURG LLP, 122 EAST 42ND STREET, SUITE 4000, NEW YORK, NY, 10168, US

(21) Appl. No.: 12/215,305

(22) Filed: Jun. 26, 2008

(30) Foreign Application Priority Data
Jul. 6, 2007 (DE) 10 2007 031 639.0

(51) Int. Cl. B65G 47/14

(52) U.S. Cl. 198/533

(57) ABSTRACT

Linear vibratory conveyor including a utility weight and a counterweight that are each vibratingly connected to a bottom plate via at least one spring element, wherein at least one piezo-electric actuator is arranged on at least one spring element for producing the opposing vibrations.

### BACKGROUND OF THE INVENTION

The invention relates to a linear vibratory conveyor including a utility weight and a counterweight that are each vibratingly connected to a bottom plate via at least one spring element.

Such linear vibratory conveyors transport small and very small components for instance to an assembling machine, where the components are either to be processed or installed. The principle on which such a linear vibratory conveyor works is based on a counterweight and a utility weight, part of which is a transport rail along which the components are moved, being caused to vibrate in opposition to one another so that the components move on the transport rail by micro-jumps. The utility weight and counterweight are each vibratingly connected via corresponding spring elements, primarily leaf springs or leaf spring packets, to the base plate, via which the linear vibratory conveyor is connected to a third article, for instance an assembly table. Normally an electromagnet is used for the drive unit, the magnet core generally being connected by the coil surrounding it to the counterweight and the magnet armature to the utility weight. When an alternating voltage is applied to the coil, an alternating magnetic field is created as a function of the voltage frequency and it acts on the armature, the opposing vibrational movement of the two weights ultimately resulting.

However, such an electromagnet, which is normally arranged in a receiving chamber beneath the utility weight between the latter and the base plate, is relatively large and therefore requires a lot of room, and it is furthermore heavy.

### SUMMARY OF THE INVENTION

An object of the invention is to provide a linear vibratory conveyor that has a simplified drive that is constructively small.

For solving this problem, it is provided in a linear vibratory conveyor of the type cited in the foregoing that at least one piezo-electric actuator is arranged on at least one spring element for producing the opposing vibrations, the piezo-electric actuator being supported on both sides on counterbearings connected to a spring element.

In accordance with the invention, instead of an electromagnet, a piezo-electric actuator is used that acts directly on a spring element, is also arranged thereon, and is not connected to the utility weight or counterweight. On the contrary, vibration-producing force actuation of a spring element itself occurs here via the piezo-electric actuator, i.e., the spring element is deformed, that is, bent, as a function of the change in shape in the piezo-electric actuator caused by the activation. The piezo-electric actuator is activated using a suitable alternating voltage, the change in shape of the actuator varying, as is known, as a function of voltage or with the voltage. The actuator, e.g. a conventional piezo-element stack, is clamped between two counterbearings so that its effective direction is largely perpendicular to the vibration direction for the spring element.

Because such actuators are very small, there are no space problems when integrating them. They are very light, i.e. they have largely no effect on the weight of the linear vibratory conveyor. Moreover, piezo-electric actuators can be activated at very high frequencies, i.e., significantly higher frequency vibrations can be produced compared to an electromagnet.

Usefully, a piezo-electric actuator is arranged on at least one spring element for the utility weight and on at least one spring element for the counterweight. Thus, the spring elements for the counterweight and for the utility weight are actively deformed for generating vibrations. In terms of the phase angle for the respective control voltages, it depends on how many and where the piezo-electric actuators are arranged, i.e., on which side of the linear conveyor they are disposed and whether they are associated with the utility weight or with the counterweight. The activation and the arrangement of the actuator or actuators must be designed such that the spring elements of the utility weight and the counterweight that are coupled to the actuators are each deformed geometrically and/or temporally opposite so that a counter-phase deformation results. Thus, depending on the embodiment, the piezo-electric actuators coupled to the different spring elements for the weights can be activated with the same phase or with an inverted phase.

Naturally it is also conceivable to arrange one piezo-electric actuator or a plurality of piezo-electric actuators on each spring element. For instance, one piezo-electric actuator can be arranged at each longitudinal end of a spring element, both actuators being activated simultaneously, that is, with the same phase. This can increase the deformation of the spring element, and thus a greater vibrational range can also be attained.

One spring element is itself usefully embodied as a leaf spring, in particular as a leaf spring packet comprising a plurality of individual springs. For one thing, such flat spring elements permit a simple arrangement of a piezo-electric actuator, and for another thing it is simple to create linear vibrational movement with them. Because normally four leaf spring packets are used, and the actuators can be arranged externally and internally thereon, there are a maximum of eight designated positions.

In order to be able to apply to or introduce into the spring element, via a piezo-electric actuator during deformation thereof, a force that leads to bending of the spring element, the actuator inventively works against two counterbearings between which it is placed or clamped. Usefully, a first counterbearing is arranged on the spring element in the area of one of the fastening elements, in particular a retention plate, that holds the spring element on the utility weight, counterweight, or base plate, or the counterbearing is formed by this fastening element itself, while a second counterbearing is arranged at a position along the spring element. The piezo-electric actuator is thus arranged or clamped between two counterbearings that are themselves securely joined to the spring element. The one counterbearing is preferably arranged adjacent for fastening the spring element on the respective weight or base plate, that is, near a location that is along the spring element and that is fixed in position because it is not bent or is hardly bent. The other end of the actuator is supported on a counterbearing positioned along the spring element. The piezo-electric actuator is thus supported on the largely fixed-position counterbearing and when there is a deformation, that is a longitudinal extension, presses against it and against the other counterbearing, resulting in a bending movement by the spring element about a transverse axis. The one counterbearing can be formed by a fastening element via which the spring element is directly joined to the base plate or to the respective weight, but it is also conceivable to provide a separate counterbearing there in the form of a metal plate or the like.

A counterbearing arranged on the spring element is usefully glued to the spring element or securely connected thereto in any desired manner. The piezo-electric actuator, which naturally has a corresponding small housing, is clamped securely between the two counterbearings.

Additional advantages, features, and details of the invention result from the exemplary embodiment described in the following and using the drawings.

### BRIEF DESCRIPTION OF THE DRAWINGS

FIG. 1 depicts the principle for an inventive linear vibratory conveyor; and

FIG. 2 is an enlarged view of two spring elements having piezo-electric actuators arranged therein.

### DESCRIPTION OF THE PREFERRED EMBODIMENTS

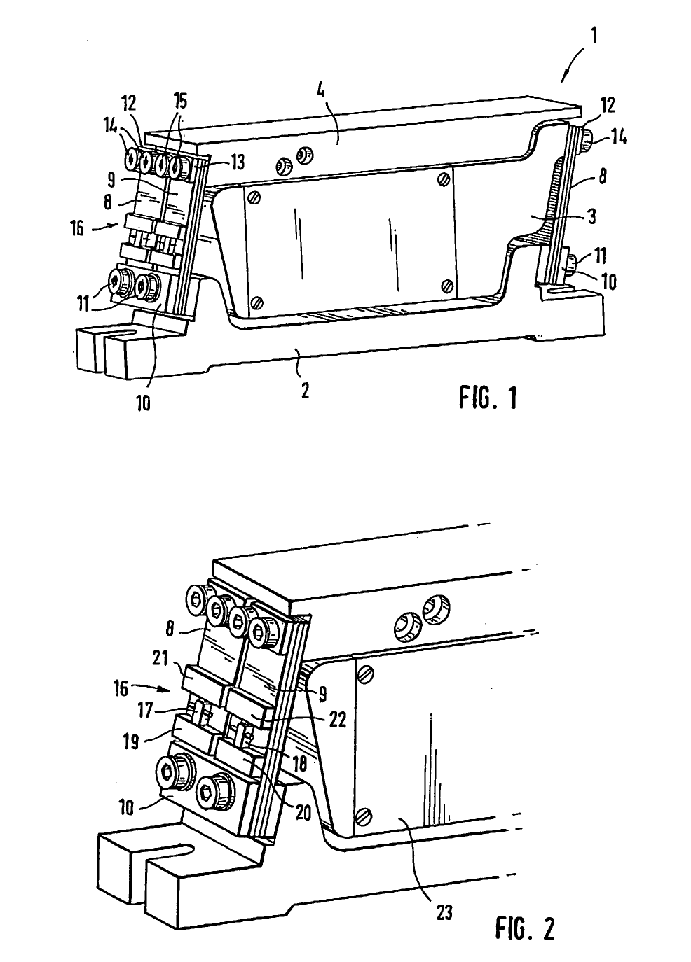

FIG. 1 depicts an inventive linear vibratory conveyor 1, including a base plate 2 to which the linear conveyor 1 is attached on an assembly table or the like. Furthermore depicted are a counterweight 3 and a utility weight 4, of which only a portion is shown because the transport rail, which is designed specific to the component and along which the components are moved, is still to be placed upon the rail-like utility weight 4. At their ends, both the counterweight 3 and the utility weight 4 are each vibratingly connected to the base plate 2 by spring elements 8, 9. The two spring elements disposed on each of the ends are arranged adjacent to one another. The embodiment is such that the two spring elements 8, via which the counterweight is connected to the base plate 2, are not arranged one after the other as viewed in the longitudinal direction of the linear conveyor 1, but rather are arranged offset to one another. The same applies to the two spring elements 9 that couple the utility weight 4 to the base plate 2, of which only one is visible in FIG. 2; these are also offset to one another. Overall the result is a crossed spring element arrangement, i.e. proceeding from the depiction in FIG. 2 the utility mass is connected on its left-hand end to the base plate 2 via a spring element 9 arranged on the right, and on the other end the spring element 9 is disposed on the left, while the counterweight is connected to the base plate 2 at the left-hand end depicted in FIG. 2 via a spring element 8 arranged on the left and on the right-hand end via the spring element 8 arranged on the right. To this end the counterweight 3 and utility weight 4 are embodied or their geometry is selected such that respective fastening positions result.

On each side, the two spring element 8, 9 are connected to the base plate 2 via a common plate-like fastening element 10, corresponding fastening screws 11 being used for this. Each of the other ends of the spring elements 8, 9 are connected to the counterweight 3 or utility weight 4 via separate plate-like fastening elements 12, 13 and corresponding fastening screws 14, 15.

In order to cause the utility weight 4 and the counterweight 3 to vibrate in opposition to one another, drive means 16 in the form of piezo-electric actuators 17, 18 are provided that are arranged on the spring elements 8, 9 and act directly on them. In FIG. 2 the two spring elements 8, 9 on the left are shown in an enlargement; the arrangement applies correspondingly for the two spring elements 8, 9 disposed on the other side and corresponding actuators 17, 18 are also arranged there on each of the spring elements 8, 9 associated with corresponding weights.

Each actuator 17, 18 is supported via a first counterbearing 19, 20, which in the example shown is arranged adjacent to the plate-like fastening element 10 or seated directly thereupon, and via a second counterbearing 21, 22, which is arranged or supported at a position along a spring element 8, 9, or is clamped between these two counterbearings. The counterbearings 19, 20, 21, 22 can be glued to the surface of the respective spring elements, which as is evident here are embodied as leaf springs or leaf spring packets, but welding them on is also conceivable.

In the example depicted, the two actuators 17, 18 are attached to the exterior side of the spring elements 8, 9. It is assumed that on the opposing side the two actuators 17, 18 arranged there and not shown in greater detail are also arranged on the exterior side of the spring elements 8, 9. I.e. that all spring elements can be acted upon directly, each via a separately controllable actuator.

In order now to enable the utility weight 4 to vibrate in opposition to the counterweight 3, it is necessary to activate the actuators 17, 18 in a certain manner. Proceeding from the configuration in accordance with FIG. 1 having spring elements 8 and 9 arranged in a cross and actuators 17, 18 arranged on the exterior side, for opposing movement it is necessary that the spring elements 8 and the spring elements 9 each be deformed in the opposite direction. I. e., two adjacent spring elements 8, 9 must be bent in opposite directions. What this leads to is that two adjacent actuators 17, 18 must necessarily be activated with inverted phase in order to cause the opposing movement. While the one actuator extends in length, that is, the spring element illustrated in FIG. 2 bends to the right due to its support on the counterbearings, the other actuator must shorten in order to enable bending in the other direction. At the same time, it is necessary that the second actuator 17 or 18 that belongs to a pair of actuators is likewise activated inverted to the first actuator 17 or 18, determined by the arrangement of the right-hand spring element 8, 9 on the exterior side. If for instance the spring element 8 shown on the left is bent to the left so that the counterweight overall is moved to the left, this being movement is effected by a change in length of the actuator 17, which is disposed on the exterior side and arranged on the right-hand spring element 8 and which bends the right-hand spring element 8 to the left due to the activation-induced lengthening and its support on the counterbearing, which bending movement the left-hand spring element 8 then follows due to the shortening of the actuator 17 there. Activation of the actuators 18 on the two spring elements 9 occurs opposite to this. Proceeding from the described example, the left-hand spring element 9 is necessarily bent to the right, which occurs via the lengthening actuator 18. At the same time, the actuator 18 there must be shortened, that is, must be activated in an inverted manner, so that the right-hand spring element 9 can also be bent to the right.

It would also be conceivable for instance to place the two actuators 17, 18 arranged on the right on the interior side of the respective spring elements 8, 9. Then inverted activation within an actuator pair 17, 17 or 18, 18 would not be necessary; on the contrary, both could be activated with the same phase of the control voltage, since both actuators must be activated in the same direction for bending a spring element. The return occurs via the spring elements that restore themselves. In corresponding manner, the actuators 17 on the spring elements 8 can also then be activated simultaneously and in an equiphase manner, in this embodiment then only bending movement to the right, with respect to all of the spring elements, being possible. The movement in the other direction always occurs via the bent spring elements themselves, which, if the actuators do not bend them actively any more, return to their starting position due to the stored restoring force. Finally, the arrangement of the actuators and their activation can be as desired to the extent that, as must merely be ensured, an opposing vibrational movement can be created between the utility weight and the counterweight via the corresponding activation.

In the example depicted, provided beneath the utility weight 4 depicted in a rail shape, in the area in which the counterweight 3 extends, is a closure plate 23, behind which is disposed a receiving chamber for balancing weights that can be used to balance counterweight and utility weight. This is necessary for proper vibrating operation, the space available here being adequate with nothing further. Because only very small, light actuators are used for generating the vibration, overall there is fundamentally the possibility of creating a lighter structure, because the weight of the normally used electromagnet is missing.

There is furthermore also the possibility of arranging a plurality actuators, that is, at least a second actuator, on each spring element 8, 9, and the possibility of not using separate counterbearing plates for each lower counterbearing, but rather using the plate-like fastening element 10 itself for this purpose.

It is also conceivable to arrange the spring elements linearly, one after the other, instead of having the crossed arrangement. In addition, it is not necessary to arrange two spring elements adjacent to one another; on the contrary, the weights can also be arranged “in one another”, i.e., e.g. the utility weight is borne via two exteriorly disposed spring elements, while the counterweight is borne via two spring elements therebetween, that is, interiorly disposed. All four spring elements in this case are in line, that is, congruent.

Fundamentally piezo-actuators can be arranged on each of the four leaf spring packets on the exterior side and/or interior side. With four leaf springs there are thus eight positions at which the actuators can be placed. With regard to the required force, just one piezo-actuator per weight is adequate, that is, one for the utility weight and one for the counterweight. Corresponding to the selected position/arrangement of the actuators, the phase angle of the respective control voltage, via which an actuator is operated, must be selected such that the spring elements deform in an equiphase manner.

The invention is not limited to the depicted exemplary embodiments. On the contrary, piezo-actuators can be used in the manner described in conveyors constructed differently.

1. Linear vibratory conveyor comprising a utility weight and a counterweight each vibratingly connected to a bottom plate via at least one spring element, at least one piezo-electric actuator arranged on at least one spring element for producing opposing vibrations, said piezo-electric actuator being supported on both sides on counterbearings connected to a spring element.

2. Linear vibratory conveyor including claim 1, characterized wherein a piezo-electric actuator is arranged on at least one spring element for said utility weight and on at least one spring element for said counterweight.

3. Linear vibratory conveyor in accordance with claim 2, wherein at least one piezo-electric actuator is arranged on all of said spring elements.

4. Linear vibratory conveyor in accordance with claim 1, wherein the piezo-electric actuators are arranged on one spring element on both longitudinal ends and are activated simultaneously.

5. Linear vibratory conveyor in accordance with claim 1, wherein the spring element is a leaf spring, in particular a leaf spring packet comprising a plurality of individual springs.

6. Linear vibratory conveyor in accordance with claim 1, wherein a first counterbearing is arranged on said spring element in the area of one of fastening elements, in particular a retention plate, that holds said spring element on said utility weight, counterweight, or base plate, or is formed by said fastening element itself, while a second counterbearing is arranged at a position along said spring element.

7. Linear vibratory conveyor in accordance with claim 6, wherein a counterbearing arranged on said spring element is usefully glued thereto or welded thereto.
